(19) United States
(12) Patent Application Publication
(10) Pub. No.: US 2026/0250924 A1
(43) Pub. Date: Aug. 27, 2026

(54) SETTLEMENT MONITORING AND TREATMENT METHOD FOR WIDENED EMBANKMENT WITH INCLINED-VERTICAL PILE RETAINING STRUCTURE, APPARATUS, AND TOOL

(71) Applicant: TIANJIN UNIVERSITY, Tianjin (CN)

(72) Inventors: Gang ZHENG, Tianjin (CN); Haizuo Zhou, Tianjin (CN); Jihui ZHAO, Tianjin (CN); Yujie ZHU, Tianjin (CN); Chenhao XIA, Tianjin (CN)

(21) Appl. No.: 19/150,414

(22) PCT Filed: Feb. 26, 2025
(86) PCT No.: PCT/CN2025/079308

§ 371 Date: Jul. 23, 2025

(30) Foreign Application Priority Data
Oct. 10, 2024 (CN) 202411406530.6

(51) Int. Cl. E02D 1/08; E02D 3/12

(52) U.S. Cl. CPC E02D 1/08; E02D 3/12

(57) ABSTRACT

A settlement monitoring and treatment method for a widened embankment with an inclined-vertical pile retaining structure, an apparatus, and a tool are provided. The method includes: acquiring target ultrasound information corresponding to a target point using a monitoring device, where the monitoring device includes a generator, a converter, and a receiver; converting the target ultrasound information using the converter to obtain first and second electrical signal information; determining signal loss information based on the first electrical signal information and the second electrical signal information; determining settlement information between the target point and a surface of a widened embankment based on the signal loss information and distance information, where the distance information represents a vertical distance between the surface of the widened embankment and a reference surface; and generating a reinforcement solution corresponding to the widened embankment based on the settlement information, soil deformation information, and a preset reinforcement strategy.

### CROSS REFERENCE TO RELATED APPLICATION(S)

This application is a Section 371 National Stage Application of International Application No. PCT/CN2025/079308, filed on Feb. 26, 2025, entitled “SETTLEMENT MONITORING AND TREATMENT METHOD FOR WIDENED EMBANKMENT WITH INCLINED-VERTICAL PILE RETAINING STRUCTURE, APPARATUS, AND TOOL”, which claims priority to Chinese Patent Application No. 202411406530.6 filed on Oct. 10, 2024, the content of which are incorporated herein by reference in their entireties.

### TECHNICAL FIELD

The present disclosure relates to a field of municipal engineering technology and road settlement monitoring technology, and in particular, to a settlement monitoring and treatment method for a widened embankment with an inclined-vertical pile retaining structure, an apparatus, and a tool.

### BACKGROUND

Under the condition that the traffic capacity of the original road does not meet the current traffic demand, widening and renovating the old road has become the main means of increasing the traffic capacity of the road. As a new type of retaining structure for widened embankment, inclined piles have advantages such as high efficiency and stability compared to traditional composite foundations and retaining wall reinforcement forms. However, it is still difficult to solve the related problems of uneven settlement and road cracking of new and old embankments. At present, road settlement monitoring mainly relies on manual monitoring, for example, a total station is used to regularly measure the road surface by setting up control datum points.

The inventors find that there are the following defects in the settlement treatment for the widened embankment in the related art: manual monitoring is mainly used, the time and labor cost is high, the real-time performance is low, and the monitoring efficiency is low; the large amount of data computation in the relevant monitoring models leads to high system resource consumption. For the new retaining method, i.e., an inclined pile structure for the widened embankment, it is urgent to propose a settlement monitoring and treatment method for the inclined pile retaining structure.

### SUMMARY

The present disclosure provides a settlement monitoring and treatment method for a widened embankment with an inclined-vertical pile retaining structure, an apparatus, a device, a storage medium, a program product, and a tool.

According to a first aspect of the present disclosure, there is provided a settlement monitoring and treatment method for a widened embankment with an inclined-vertical pile retaining structure, including: acquiring target ultrasound information corresponding to a target point by using a monitoring device, where the monitoring device includes a generator, a converter, and a receiver; converting the target ultrasound information by using the converter to obtain first electrical signal information and second electrical signal information, where the first electrical signal information represents information obtained after the converter converts first ultrasound information transmitted by the generator, and the second electrical signal information represents information obtained after the converter converts second ultrasound information received by the receiver; determining signal loss information based on the first electrical signal information and the second electrical signal information; determining settlement information between the target point and a surface of a widened embankment based on the signal loss information and distance information, where the distance information represents a vertical distance between the surface of the widened embankment and a reference surface; and generating a reinforcement solution corresponding to the widened embankment based on the settlement information, soil deformation information, and a preset reinforcement strategy, where the reinforcement solution includes to-be-reinforced range information and configuration information corresponding to a reinforcement tool.

A second aspect of the present disclosure provides a settlement monitoring and treatment apparatus for a widened embankment with an inclined-vertical pile retaining structure, including: a target ultrasound information acquisition module configured to acquire target ultrasound information corresponding to a target point by using a monitoring device, where the monitoring device includes a generator, a converter, and a receiver; a target ultrasound information conversion module configured to convert the target ultrasound information by using the converter to obtain first electrical signal information and second electrical signal information, where the first electrical signal information represents information obtained after the converter converts first ultrasound information transmitted by the generator, and the second electrical signal information represents information obtained after the converter converts second ultrasound information received by the receiver; a signal loss information determination module configured to determine signal loss information based on the first electrical signal information and the second electrical signal information; a settlement information determination module configured to determine settlement information between the target point and a surface of a widened embankment based on the signal loss information and distance information, where the distance information represents a vertical distance between the surface of the widened embankment and a reference surface; and a reinforcement solution generation module configured to generate a reinforcement solution corresponding to the widened embankment based on the settlement information, soil deformation information, and a preset reinforcement strategy, where the reinforcement solution includes to-be-reinforced range information and configuration information corresponding to a reinforcement tool.

A third aspect of the present disclosure provides an electronic device, including: one or more processors; and a memory configured to store one or more computer programs, where the one or more processors execute the one or more computer programs to implement the steps of the method described above.

A fourth aspect of the present disclosure provides a computer-readable storage medium having a computer program or instruction stored thereon, where the computer program or instruction, when executed by a processor, is allowed to implement the steps of the method described above.

A fifth aspect of the present disclosure provides a computer program product including a computer program or instruction, where the computer program or instruction, when executed by a processor, is allowed to implement the steps of the method described above.

A sixth aspect of the present disclosure provides a reinforcement tool, including: a grouting pipe body constructed as a hollow metal pipe body and configured to input or output a reinforcing grout, where the grouting pipe body includes a first grouting pipe body and a second grouting pipe body, a diameter of the first grouting pipe body is less than a diameter of the second grouting pipe body, a first end of the first grouting pipe body is detachably connected to a grout supply device, and a second end of the first grouting pipe body is detachably connected to a first end of the second grouting pipe body; and a grouting bag constructed at an interface between a widened embankment and a pile body and configured to inject the reinforcing grout, where a second end of the second grouting pipe body is detachably connected to a first end of the grouting bag.

### BRIEF DESCRIPTION OF THE DRAWINGS

FIG. 1 shows an application scenario diagram of a settlement monitoring and treatment method for a widened embankment with an inclined-vertical pile retaining structure, an apparatus, a device, a storage medium, and a program product according to embodiments of the present disclosure.

FIG. 2 shows a flowchart of a settlement monitoring and treatment method for a widened embankment with an inclined-vertical pile retaining structure according to embodiments of the present disclosure.

FIG. 3 shows cross-sectional and side view schematic diagrams of an arrangement of a monitoring device and a reinforcement tool in a widened embankment according to embodiments of the present disclosure, where figure (a) shows a cross-sectional schematic diagram of the arrangement of the monitoring device and the reinforcement tool in the widened embankment, figure (b) shows a side view schematic diagram of the arrangement of the monitoring device and the reinforcement tool in the widened embankment, and figure (c) shows a top view schematic diagram of the arrangement of the monitoring device and the reinforcement tool in the widened embankment.

FIG. 4 shows a cross-sectional schematic view of a monitoring device according to embodiments of the present disclosure.

FIG. 5 shows a schematic diagram of a control range of a reinforcement tool according to embodiments of the present disclosure.

FIG. 6 shows a schematic diagram of a relationship curve between a ratio of a horizontal influence range of an embankment to a grouting bag depth, and a soil elastic modulus according to embodiments of the present disclosure.

FIG. 7 shows a structural block diagram of a settlement monitoring and treatment apparatus for a widened embankment with an inclined-vertical pile retaining structure according to embodiments of the present disclosure.

FIG. 8 shows front view and top view schematic diagrams of a reinforcement tool according to embodiments of the present disclosure, where figure (a) is a front view schematic diagram of the reinforcement tool, and figure (b) is a top view schematic diagram of the reinforcement tool.

FIG. 9 shows a block diagram of an electronic device adapted to implement a settlement monitoring and treatment method for a widened embankment with an inclined-vertical pile retaining structure according to embodiments of the present disclosure.

### DETAILED DESCRIPTION OF EMBODIMENTS

Embodiments of the present disclosure will be described below with reference to the accompanying drawings. It should be understood, however, that these descriptions are merely exemplary and are not intended to limit the scope of the present disclosure. In the following detailed descriptions, for purposes of explanation, numerous specific details are set forth in order to provide a thorough understanding of embodiments of the present disclosure. It is obvious, however, that one or more embodiments may be implemented without these specific details. In addition, in the following descriptions, descriptions of well-known structures and technologies are omitted to avoid unnecessarily obscuring the concept of the present disclosure.

Terms used herein are for the purpose of describing specific embodiments only and are not intended to limit the present disclosure. Terms “comprising”, “including” and the like used herein specify a presence of the feature, step, operation and/or component, but do not preclude a presence or addition of one or more other features, steps, operations or components.

All terms (including technical and scientific terms) used herein have the meaning as commonly understood by those skilled in the art, unless otherwise defined. It should be noted that the terms used herein should be construed to have meanings consistent with the context of the specification and should not be construed in an idealized or overly rigid manner.

Where expressions like “at least one of A, B, and C, etc.” are used, they should generally be interpreted in accordance with the meaning of the expression as commonly understood by those skilled in the art (e.g., “a system having at least one of A, B and C” should include, but not be limited to, a system having A alone, having B alone, having C alone, having A and B, having A and C, having B and C, and/or having A, B, C, etc.).

In the technical solution of the present disclosure, the user information (including but not limited to user personal information, user image information, user device information, such as location information, etc.) and data (including but not limited to data used for analysis, stored data, displayed data, etc.) involved are all information and data authorized by the user or fully authorized by all parties, and the collection, storage, use, processing, transmission, provision, disclosure and application of relevant data comply with relevant laws, regulations and standards, take necessary confidentiality measures, do not violate public order and good customs, and provide corresponding operation entrances for the user to choose authorization or refusal.

In the process of conceptualizing the present disclosure, the inventors find that in the related art, settlement monitoring of the widened embankment mainly relies on manual monitoring, which has high time and labor costs, low real-time performance, and low monitoring efficiency; the large amount of data computation in the relevant monitoring models leads to high system resource consumption; for the new retaining method, i.e., an inclined pile structure for the widened embankment, there is no corresponding technical solution for embankment settlement monitoring and settlement repair and reinforcement.

In view of the above, in the present disclosure, first electrical signal information and second electrical signal information are automatically generated by converting target ultrasound information, so as to obtain signal loss information between the first electrical signal information and the second electrical signal information; settlement information between a target point and a surface of a widened embankment is generated in real time by combining the signal loss information with distance information; and then to-be-reinforced range information and reinforcement tool configuration information are automatically generated based on the settlement information, soil deformation information, and a preset reinforcement strategy. In this way, the waste of reinforcement device and reinforcement materials caused by inaccurate detection of the to-be-reinforced range is avoided, reinforcement costs are reduced, and reinforcement of the widened embankment is achieved. Since the settlement monitoring of the embankment may be achieved by only using the electrical signal information of the target point and the distance information, the amount of calculation information is small, which saves the consumption of system resources, improves the monitoring efficiency, and fills a technical gap in the field of settlement monitoring and settlement repair and reinforcement technology for the embankment with an inclined-vertical pile retaining structure in the related art.

Embodiments of the present disclosure provide a settlement monitoring and treatment method for a widened embankment with an inclined-vertical pile retaining structure, including: acquiring target ultrasound information corresponding to a target point by using a monitoring device, where the monitoring device includes a generator, a converter, and a receiver; converting the target ultrasound information by using the converter to obtain first electrical signal information and second electrical signal information, where the first electrical signal information represents information obtained after the converter converts first ultrasound information transmitted by the generator, and the second electrical signal information represents information obtained after the converter converts second ultrasound information received by the receiver; determining signal loss information based on the first electrical signal information and the second electrical signal information; determining settlement information between the target point and a surface of a widened embankment based on the signal loss information and distance information, where the distance information represents a vertical distance between the surface of the widened embankment and a reference surface; and generating a reinforcement solution corresponding to the widened embankment based on the settlement information, soil deformation information, and a preset reinforcement strategy, where the reinforcement solution includes to-be-reinforced range information and configuration information corresponding to a reinforcement tool.

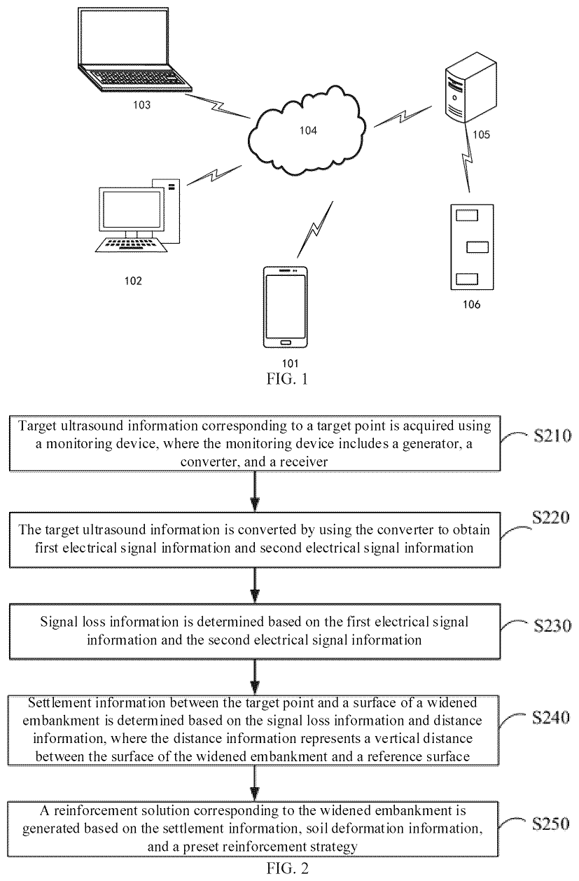

FIG. 1 shows an application scenario diagram of a settlement monitoring and treatment method for a widened embankment with an inclined-vertical pile retaining structure, an apparatus, a device, a storage medium, and a program product according to embodiments of the present disclosure.

As shown in FIG. 1, the application scenario according to the embodiment may include a first terminal device 101, a second terminal device 102, a third terminal device 103, a network 104, a server 105, and a monitoring device 106. The network 104 is a medium for providing a communication link between the first terminal device 101, the second terminal device 102, the third terminal device 103, the server 105, and the monitoring device 106. The network 104 may include various types of connections, such as wired, wireless communication links, fiber optic cables, or the like.

The monitoring device 106 may include a generator (such as an ultrasonic reflector, a transmitting probe), a converter, a receiver (such as a receiving probe), a power supply, and a processing device. The generator may be driven by an electrical signal to vibrate a piezoelectric crystal or a magnetostrictive material inside the generator, thereby generating an ultrasonic wave. The converter may be used to convert electrical energy into mechanical energy, and may also convert received ultrasound information into electrical signal information and transmit the electrical signal information to the processing device for processing. The processing device may determine the settlement information of the widened embankment by calculating relevant information, then determine whether to perform a settlement reinforcement operation based on the settlement information and a settlement threshold, and then control a grout supply device (such as a grouting pump, an automatic pump) to perform a grouting operation.

In a feasible embodiment, the controller may also be connected to the server 105 through the network 104, and calculate the settlement information through the server 105 to instruct the grout supply device to perform a grouting reinforcement operation.

A user may use at least one of the first terminal device 101, the second terminal device 102, and the third terminal device 103 to interact with the server 105 through the network 104 to receive or send a message or the like. Various communication client applications, such as shopping applications, web browser applications, search applications, instant messaging tools, email clients, social platform software, and the like (for example only), may be installed on the first terminal device 101, the second terminal device 102, and the third terminal device 103.

The first terminal device 101, the second terminal device 102, and the third terminal device 103 may be various electronic devices having a display screen and supporting web browsing, including but not limited to a smartphone, a tablet computer, a laptop computer, a desktop computer, and the like.

The server 105 may be a server that provides various services, such as a backend management server (for example only) that supports a website browsed by a user using the first terminal device 101, the second terminal device 102, and the third terminal device 103. The backend management server may perform processing such as analyzing the received data such as the user request, and feedback the processing result (for example, a web page, information, data, and the like acquired or generated according to the user request) to the terminal device.

It should be noted that the settlement monitoring and treatment method for the widened embankment with the inclined-vertical pile retaining structure provided in embodiments of the present disclosure may generally be executed by the server 105. Correspondingly, the settlement monitoring and treatment apparatus for the widened embankment with the inclined-vertical pile retaining structure provided in embodiments of the present disclosure may generally be provided in the server 105. The settlement monitoring and treatment method for the widened embankment with the inclined-vertical pile retaining structure provided in embodiments of the present disclosure may also be executed by a server or server cluster that is different from the server 105 and communicates with the first terminal device 101, the second terminal device 102, the third terminal device 103, and/or the server 105. Correspondingly, the settlement monitoring and treatment apparatus for the widened embankment with the inclined-vertical pile retaining structure provided in embodiments of the present disclosure may also be provided in a server or server cluster that is different from the server 105 and communicates with the first terminal device 101, the second terminal device 102, the third terminal device 103, and/or the server 105.

It should be understood that the number of terminal devices, networks, monitoring devices, and servers in FIG. 1 is merely illustrative. According to implementation needs, there may be any number of terminal devices, networks, monitoring devices, and servers.

FIG. 2 shows a flowchart of a settlement monitoring and treatment method for a widened embankment with an inclined-vertical pile retaining structure according to embodiments of the present disclosure.

As shown in FIG. 2, the settlement monitoring and treatment method for the widened embankment with the inclined-vertical pile retaining structure in the embodiment includes operation S210 to operation S250.

In operation S210, target ultrasound information corresponding to a target point is acquired using a monitoring device, where the monitoring device includes a generator, a converter, and a receiver.

According to embodiments of the present disclosure, the settlement information of the widened embankment may be acquired by acquiring and processing the ultrasound information using the monitoring device, and a reinforcement operation may be performed on the target point in the embankment for the settlement information exceeding a preset settlement threshold. A plurality of monitoring devices may be provided, which may be arranged on the road surface of the widened embankment and may be settled together with the road surface in the service process of the embankment. Each monitoring device may include a generator, a converter, and a receiver. Different monitoring devices are set up for different target points, and the ultrasonic frequencies transmitted by the generators corresponding to the monitoring devices are different. It may be understood that the frequency of the ultrasound information received by the same monitoring device is consistent with the frequency of the ultrasound information transmitted.

In operation S220, the target ultrasound information is converted by using the converter to obtain first electrical signal information and second electrical signal information, where the first electrical signal information represents information obtained after the converter converts first ultrasound information transmitted by the generator, and the second electrical signal information represents information obtained after the converter converts second ultrasound information received by the receiver.

According to embodiments of the present disclosure, the converter may also be referred to as a transducer, the transducer may convert high-frequency electrical energy transmitted by the power supply into high-frequency mechanical vibration, and a high-voltage shock wave is generated through the generator to excite the transmitting probe to transmit the ultrasound information; after the ultrasound information is transmitted, it may be recognized and received by the receiver after being reflected by the ultrasonic reflective coating on the vertical pile in the soil. It may be understood that the receiver only recognizes and receives ultrasound information with the same frequency as the initial transmitted ultrasound information. After receiving the ultrasound information with the same frequency, the transducer may convert the received ultrasound information into electrical signal information, and then transmit the electrical signal information to the processing device for processing.

In operation S230, signal loss information is determined based on the first electrical signal information and the second electrical signal information.

According to embodiments of the present disclosure, the first electrical signal information may be the electrical signal information corresponding to the first ultrasound information transmitted by the generator, and the second electrical signal information may be the electrical signal information corresponding to the second ultrasound information received by the receiver. By calculating a difference value between the first electrical signal information and the second electrical signal information, the signal loss information may be obtained. It may be understood that the signal loss information may be represented by loss percentage and/or difference value, which is not limited here.

In operation S240, settlement information between the target point and a surface of a widened embankment is determined based on the signal loss information and distance information, where the distance information represents a vertical distance between the surface of the widened embankment and a reference surface.

According to embodiments of the present disclosure, the reference surface may represent a ground (a design elevation of a ground) that is less than a design elevation (i.e., a design elevation before settlement occurs) of the surface of the widened embankment, and the distance information between the reference surface and the embankment surface may be determined based on actual engineering, which is not specifically limited here. The settlement information may represent a difference value between the current embankment surface elevation and the design elevation. By comparing the settlement information with the preset settlement threshold, it may be determined whether the current widened embankment surface needs to be reinforced.

In operation S250, a reinforcement solution corresponding to the widened embankment is generated based on the settlement information, soil deformation information, and a preset reinforcement strategy, where the reinforcement solution includes to-be-reinforced range information and configuration information corresponding to a reinforcement tool.

According to embodiments of the present disclosure, the soil deformation information may represent the deformation capacity and its related physical characteristics of soil under the action of an external applied force, and may include an elastic modulus, a friction angle, a cohesive force, and a shear modulus. The preset reinforcement strategy may be a strategy of using the reinforcement tool to reinforce the widened embankment that has experienced settlement based on the soil deformation information and the settlement information. The to-be-reinforced range information may represent region information (such as area information and depth information) that is formed by at least one target point and needs settlement repair and reinforcement. The configuration information corresponding to the reinforcement tool may represent quantity information, installation location information, and material configuration information of the reinforcement tool.

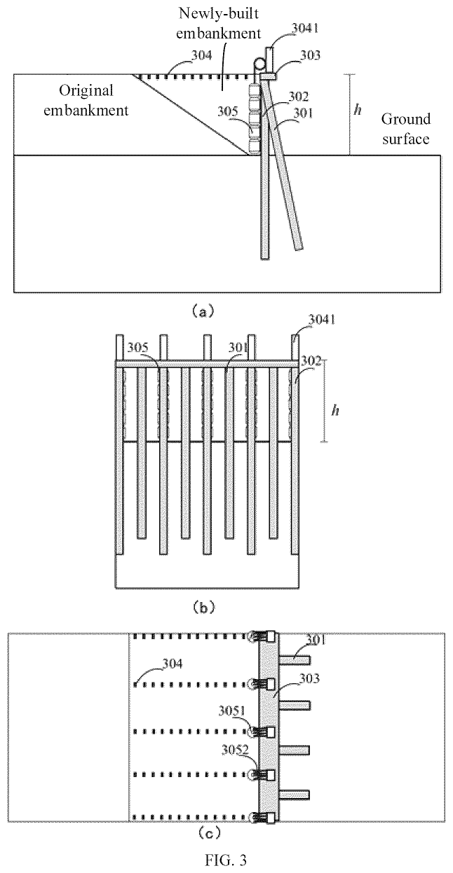

FIG. 3 shows cross-sectional and side view schematic diagrams of an arrangement of a monitoring device and a reinforcement tool in a widened embankment according to embodiments of the present disclosure.

As shown in FIG. 3, figure (a) shows a cross-sectional schematic diagram of the arrangement of the monitoring device and the reinforcement tool in the widened embankment, and figure (b) shows a side view schematic diagram of the arrangement of the monitoring device and the reinforcement tool in the widened embankment. The widened embankment may include an original embankment and a newly-built embankment. The inclined pile retaining structure in the widened embankment may include an inclined pile 301 and a vertical pile 302. The inclined pile 301 and the vertical pile 302 may be pre-stressed pipe piles, and the vertical pile 302 and the inclined pile 301 may be alternately arranged and connected by a top beam 303. A distance from the top beam 303 along the vertical pile to the ground surface may be denoted as h. Reference may be made to the inventor's patent “Outward oblique and straight alternating synergistic reinforcing system for widening roadbed on soft soil foundation” to achieve reinforcement and maintenance for the widened road. On this basis, in the present disclosure, road settlement monitoring devices 304 are arranged at intervals along a centerline of the vertical pile 302 on the surface of the widened embankment, for the inclined-vertical pile body. The monitoring device 304 may further include a grouting control device 3041. In a case that the monitored settlement information exceeds the preset settlement threshold, the reinforcement device 305 may be used to perform a grouting reinforcement operation on a settlement region of the widened embankment. Figure (c) shows a top view schematic diagram of the arrangement of the monitoring device and the reinforcement tool in the widened embankment. The reinforcement device 305 includes a grouting bag 3051 and a grouting pipe body 3052.

FIG. 4 shows a cross-sectional schematic view of a monitoring device according to embodiments of the present disclosure.

As shown in FIG. 4, the monitoring device may include a power supply 401, a converter 402, a generator 403, a probe 404, and a processing device 405. The generator 403 may be driven by the power source 401 to vibrate the piezoelectric crystal or magnetostrictive material inside the generator 403 to generate a high-voltage shock wave and excite the probe 404 to transmit an ultrasonic wave (ultrasound information). The converter 402 may be used to convert electrical energy into mechanical energy, and may also convert received ultrasound information into electrical signal information and transmit the electrical signal information to the processing device 405 for processing. The processing device 405 may determine the settlement information of the widened embankment by calculating relevant information, then determine whether to perform a settlement reinforcement operation based on the settlement information and the settlement threshold, and then control a grout supply device (such as a grouting pump, an automatic pump) to perform a grouting operation. The power supply 401 may automatically obtain electrical energy from a solar panel arranged on an edge of the road embankment.

In a feasible embodiment, the generator 403 may generate an ultrasonic signal with a frequency bandwidth in a range of 1 MHz to 10 MHz, and a monitoring rate of the monitoring device may be set to one time per second. The ultrasonic signals transmitted by the embankment settlement monitoring device may adopt beamforming technology, and the ultrasonic waves are directionally propagated in a fixed direction. The ultrasonic waves may be recognized and received by the probe 404 after being reflected by the ultrasonic reflective coating. The probe 404 may use frequency memory metal to only recognize ultrasonic waves with the same frequency as the transmitted ultrasonic waves. Furthermore, the surface of the probe 404 may be coated with acrylic resin to improve the corrosion resistance of the probe.

In a feasible embodiment, the monitoring devices in the widened embankment surface layer may be numbered by using the monitoring devices, and ultrasonic waves with different frequencies may be achieved by adjusting the amplification factor of the generator. For example, a frequency of an ultrasonic wave transmitted by a monitoring device N1 is f1, and a frequency of an ultrasonic wave transmitted by a monitoring device N2 is f2. The influence of soil medium on ultrasonic wave propagation may be negligible, but the ultrasonic wave may be reflected by the ultrasonic reflective coating. The receiving probe in each monitoring device has a fixed-frequency recognition function to receive the ultrasonic wave with the same frequency as the original frequency, and the converter converts it into electrical signal information and transmits the electrical signal information to the processing device. The specific method for determining signal loss information i is specifically shown in the following Equation (1).

$$i = \frac{m}{{m}_{i}} ; \qquad ( 1 )$$

where mᵢ represents the first electrical signal information, m represents the second electrical signal information, and i represents the signal loss information (current loss percentage).

In a feasible embodiment, a concentration of the ultrasonic reflective coating may decrease linearly from the top beam at the top of the vertical pile in the embankment retaining structure to the reference surface (ground surface). It may be seen from experiments that when the concentration of the ultrasonic reflective coating is 1.5 kg/m², all ultrasonic waves may be reflected, and the amount of reflection is directly proportional to the concentration of the ultrasonic reflective coating. At the position of the top beam, the coating concentration is high, all ultrasonic waves may be reflected back, and for the monitoring device, the received electrical signal information is almost the same as the transmitted electrical signal information. When settling to the position of the reference surface, the coating concentration is 0, and reflection information for the ultrasound information is almost zero, that is, the received electrical signal information is 0. The settlement information of the embankment monitoring target point is denoted as s, and the calculation equation for the settlement information s is specifically shown in the following Equation (2):

$$s = ( 1 - i ) \times h ; \qquad ( 2 )$$

where h represents a distance from the top beam along the vertical pile to the ground surface, and i represents the signal loss information.

According to embodiments of the present disclosure, first electrical signal information and second electrical signal information are automatically generated by converting target ultrasound information, so as to obtain signal loss information between the first electrical signal information and the second electrical signal information; settlement information between a target point and a surface of a widened embankment is generated in real time by combining the signal loss information with distance information; and then to-be-reinforced range information and reinforcement tool configuration information are automatically generated based on the settlement information, soil deformation information, and a preset reinforcement strategy. In this way, the waste of reinforcement device and reinforcement materials caused by inaccurate detection of the to-be-reinforced range is avoided, reinforcement costs are reduced, and reinforcement of the widened embankment is achieved. Since the settlement monitoring of the embankment may be achieved by only using the electrical signal information of the target point and the distance information, the amount of calculation information is small, which saves the consumption of system resources, improves the monitoring efficiency, and fills a technical gap in the field of settlement monitoring and settlement repair and reinforcement technology for the embankment with an inclined-vertical pile retaining structure in the related art.

According to embodiments of the present disclosure, the second electrical signal information is determined by the following operation: receiving, by using the receiver, the first ultrasound information after being reflected to generate the second ultrasound information, where an ultrasound frequency of the first ultrasound information is the same as an ultrasound frequency of the second ultrasound information; and converting the second ultrasound information by using the converter to obtain the second electrical signal information.

According to embodiments of the present disclosure, in order to ensure that the frequency of the ultrasound information recognized and received by the receiver is the same as the frequency of the original ultrasound information transmitted by the generator, various methods may be adopted. For example, the receiver may be designed to receive ultrasonic signals with a specific frequency, and the transmitter and the receiver of the ultrasonic sensor are designed according to the same frequency, so as to ensure that the receiver may effectively capture the ultrasonic signal transmitted by the transmitter. For another example, in a case that the transmitter is a receiving probe, frequency memory metal may be used to only recognize ultrasound information with the same frequency as the ultrasound transmission pulse wave, and ultimately achieve that the ultrasound frequency of the first ultrasound information is the same as the ultrasound frequency of the second ultrasound information.

In a feasible embodiment, the conversion of ultrasound information to electrical signal information may be achieved using a converter (such as a piezoelectric sensor or a piezoelectric transducer). The converter may convert mechanical vibration (ultrasound information) into electrical signal information, i.e., a piezoelectric effect. The specific method may include: the ultrasonic wave (ultrasound information) propagates to a surface of the piezoelectric sensor through air or soil; when the ultrasonic wave hits the surface of the piezoelectric sensor, it may cause slight displacement and deformation inside the piezoelectric material, resulting in uneven distribution of positive and negative charges inside the piezoelectric material, thereby generating a charge; the generated charge may be captured and collected by an electrode of the sensor, and converted into a voltage or current signal; furthermore, the generated electrical signal may be amplified and processed through an amplifier and a filter to meet the needs of specific applications.

According to embodiments of the present disclosure, the strength of the electrical signal may be enhanced through the converter, the amplifier, and the filter, and by increasing the voltage or current of the signal, different requirements of application scenarios and practical engineering may be met. Meanwhile, the amplifier may precisely adjust the amplification factor of the signal to optimize the signal strength according to the needs of the specific application, thereby improving the sensitivity and stability of the system.

According to embodiments of the present disclosure, the generating a reinforcement solution corresponding to the widened embankment based on the settlement information, soil deformation information, and a preset reinforcement strategy includes: determining the to-be-reinforced range information based on the settlement information and a preset settlement threshold; and determining the configuration information based on the to-be-reinforced range information, the soil deformation information, and the preset reinforcement strategy.

According to embodiments of the present disclosure, the preset settlement threshold may be determined based on the actual situation and the specific engineering. For example, the preset settlement threshold may be 3 cm. When the settlement value, which is monitored by the monitoring device, between the target point of the widened embankment and the design elevation of the target point is greater than or equal to 3 cm, a settlement platform may generate early warning information for alarm. Based on the settlement information, the monitoring device may automatically generate the area information and depth information of the target point (i.e., the to-be-reinforced point).

According to embodiments of the present disclosure, the soil deformation information may include an elastic modulus, a shear modulus, a soil friction angle, or a cohesive force, which may be acquired based on measured data from a laboratory test or a site investigation. For example, the elastic modulus may be determined through a uniaxial compression test, i.e., a soil sample is subjected to axial pressure, and the strain proportional to the pressure is measured, such that the elastic modulus of the soil may be calculated. The shear modulus may be determined by a direct shear test or a triaxial shear test, in which shear stress may be applied and the strain of the soil may be measured; and the shear modulus is calculated by the relationship between the shear stress and the shear strain. The soil deformation information may be stored in the processing device of the monitoring device or the server connected to the monitoring device, and may be retrieved at any time according to needs.

It should be noted that in the present disclosure, the relationship between the reinforcement tool for the embankment settlement information and different soil deformation information may be obtained by changing the soil deformation information (which may include the soil friction angle φ, the elastic modulus E, and the cohesive force c) through experiments. Adjusting the soil friction angle φ and the cohesive force c of the embankment is not obvious on the reinforcement tool lifting the embankment settlement horizontal influence range, and may be ignored, while there is a corresponding relationship between the settlement horizontal influence range and the elastic modulus E. The reinforcement tool may be a grouting bag and a grouting pipe body arranged between the widened embankment and the reinforcement pile. The depth of the grouting bag driven into the embankment and the length of the grouting bag may be determined according to the calculation equation of the horizontal influence range of the grouting bag, as shown in the following Equation (3):

$$l = ( 2. {e}^{- 0.025 E} + 0.24 ) y ; \qquad ( 3 )$$

where E is the soil elastic modulus, y is the depth at which the grouting bag is driven into the embankment, and l is the horizontal influence range of the grouting bag. The configuration information may include the quantity information and the location information of the reinforcement tool.

According to embodiments of the present disclosure, after determining the soil elastic modulus and the reinforcement region, the most suitable reinforcement tools and materials may be selected and configured. Reinforcement materials with different types or strengths are selected for different soil elastic moduli, which may help optimize the reinforcement solution, avoid unnecessary waste, minimize construction costs, and reduce subsequent maintenance costs.

According to embodiments of the present disclosure, the determining the to-be-reinforced range information based on the settlement information and a preset settlement threshold includes: determining the to-be-reinforced range information in a case that the settlement information is greater than or equal to the preset settlement threshold, where the to-be-reinforced range information represents region information formed by at least one to-be-reinforced point.

According to embodiments of the present disclosure, the to-be-reinforced range information may be a region range composed of a plurality of to-be-reinforced points or a single to-be-reinforced point (target point). For example, the to-be-reinforced points are D1, D2, D3, and D4, and D1, D2, D3, and D4 are adjacent points with areas of S1, S2, S3, and S4, respectively, then the to-be-reinforced range information may be determined as Sₛᵤₘ=S1+S2+S3+S4.

According to embodiments of the present disclosure, the soil deformation information represents deformation feature information of soil at the target point under stress, where the determining the configuration information based on the to-be-reinforced range information, the soil deformation information, and the preset reinforcement strategy includes: acquiring reinforcement energy efficiency information and the soil deformation information, where the reinforcement energy efficiency information represents reinforcement capability information of the reinforcement tool for a to-be-reinforced point, and the reinforcement energy efficiency information is associated with the soil deformation information at the to-be-reinforced point; and determining the configuration information based on the soil deformation information, the reinforcement energy efficiency information, the to-be-reinforced range information, and the preset reinforcement strategy, where the configuration information includes quantity information and location information corresponding to the reinforcement tool.

FIG. 5 shows a schematic diagram of a control range of a reinforcement tool according to embodiments of the present disclosure.

The reinforcement energy efficiency information may be determined based on the reinforcement capability of the reinforcement tool at the to-be-reinforced point. As shown in FIG. 5, assuming that the intersection point between a centerline of a grouting bag 501 and a design elevation of a newly-built embankment 502 is O, a top of the grouting bag 501 is a grouting pipe body 503, a top position of the grouting bag 501 is y1, a bottom position of the grouting bag 501 is y2, the minimum horizontal influence range of the road surface by the grouting bag 501 is l₁, and the maximum horizontal influence range of the road surface by the grouting bag 501 is l₂. It should be noted that, assuming in a single grouting process, the influence range of the grouting bag is within 5 cm of the horizontal road surface centered on the point O; within this range, the minimum value of settlement lift is less than 20% of the maximum value, and it may be considered that the influence of the grouting bag on the embankment ends here. It may be understood that the total depth y of the grouting bags driven into the embankment is the sum of the heights hi of individual grouting bags, i.e., the number of the grouting bags may be determined by the total depth y of the grouting bags. In addition to the quantity information and the location information of the reinforcement tool, the configuration information may further include material configuration information (i.e., information of the grout material injected into the grouting bag) and material information (such as rubber material) of the grouting bag itself.

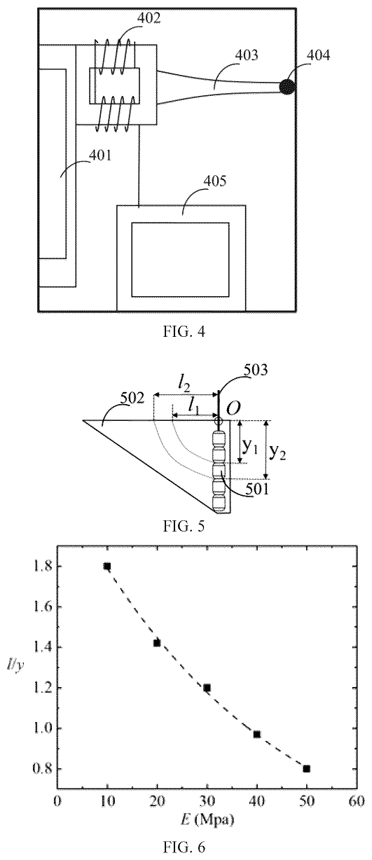

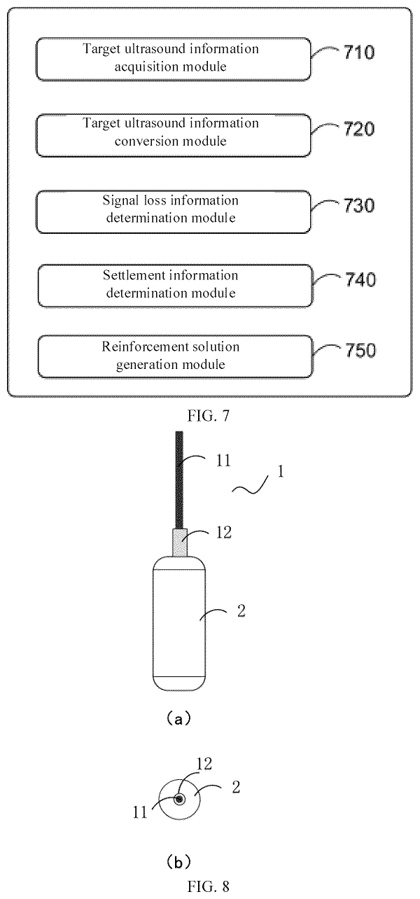

FIG. 6 shows a schematic diagram of a relationship curve between a ratio of a horizontal influence range of an embankment to a grouting bag depth, and a soil elastic modulus according to embodiments of the present disclosure.

As shown in FIG. 6, the horizontal axis represents the soil elastic modulus E, and the vertical axis represents the ratio (l/y) of the horizontal influence range of the embankment to the grouting bag depth. It may be seen that the ratio (l/y) of the horizontal influence range of the embankment to the grouting bag depth is inversely proportional to the soil elastic modulus E, that is, the greater the soil elastic modulus E, the less the ratio (l/y) of the horizontal influence range of the embankment to the grouting bag depth. The soil elastic modulus E is directly proportional to the grouting bag depth y and inversely proportional to the horizontal influence range of the embankment. As shown in Table 1, the influence data of the grouting bag on the settlement horizontal distance range of the widened embankment according to embodiments of the present disclosure are presented.

TABLE 1

| | | | | | Grouting | | | | |
|---|---|---|---|---|---|---|---|---|---|
| | Elastic | Cohesive | Friction | Grouting | bag | Influence | Influence | | |
| Fill soil | modulus | force | angle | bag top | bottom | range | range | | |
| Symbol | E | C | φ | y₁ | y₂ | l₁ | l₂ | | |
| (unit) | (MPa) | (Kpa) | (°) | (m) | (m) | (m) | (m) | l₁/y₁ | l₂/y₂ |
| 1 | 30 | 0 | 43 | 0.50 | 3.50 | 0.62 | 4.34 | 1.24 | 1.24 |
| 2 | 30 | 20 | 43 | 0.50 | 3.50 | 0.61 | 4.27 | 1.22 | 1.22 |
| 3 | 30 | 20 | 43 | 0.50 | 3.50 | 0.62 | 4.44 | 1.24 | 1.24 |
| 4 | 30 | 20 | 0 | 0.50 | 3.50 | 0.61 | 4.42 | 1.22 | 1.22 |
| 5 | 10 | 0 | 43 | 0.50 | 3.50 | 0.92 | 6.44 | 1.84 | 1.84 |
| 6 | 20 | 0 | 43 | 0.50 | 3.50 | 0.71 | 4.97 | 1.42 | 1.42 |
| 7 | 40 | 0 | 43 | 0.50 | 3.50 | 0.49 | 3.43 | 0.98 | 0.98 |
| 8 | 50 | 0 | 43 | 0.50 | 3.50 | 0.41 | 2.87 | 0.82 | 0.82 |

According to embodiments of the present disclosure, the depth and quantity of the grouting bags may be accurately determined based on the actual characteristics and elastic modulus of the soil, so as to maximize the reinforcement effect. Determining the influence data of the depth and quantity of the grouting bags on the settlement horizontal distance range of the widened embankment may reduce uncertainty and risks in the project implementation, ensure that the reinforcement effect meets the design expectation, and avoid excessive or insufficient use of the grouting bags, which may save costs, ensure the optimal utilization of resources in the process of settlement embankment reinforcement, and improve the economy of settlement repair projects.

According to embodiments of the present disclosure, the method further includes: generating a plurality of target ultrasound information having different frequency information; and triggering a frequency update mechanism in response to detecting a presence of interference information in environmental information, so as to update frequency information corresponding to the target ultrasound information and acquire an updated target ultrasound information, where the interference information represents information having a same ultrasound frequency as the target ultrasound information, and an updated frequency information is ultrasound frequency information not appeared in the environmental information.

According to embodiments of the present disclosure, in order to distinguish different target points, the monitoring device may transmit ultrasound information with different frequencies for different target points. In order to prevent ultrasonic pollution, the monitoring device may transmit the ultrasound information with different frequencies by setting the frequency update mechanism.

In a feasible embodiment, an ultrasonic monitoring device (e.g. an ultrasonic sensor) in the monitoring device may be used to analyze the data acquired from the sensor using a signal processing algorithm, so as to identify the ultrasonic frequency and its intensity present in the current environment. By triggering frequency updates periodically or upon detecting a specific ultrasonic pollution frequency, in order to ensure an ultrasonic generator has a programmable frequency function, a transmission frequency may be changed by a control signal or command; and at the same time, when the frequency is updated, it may be ensured that the frequency update operation does not interfere with the frequencies of ultrasonic waves at other target points.

According to embodiments of the present disclosure, by detecting environmental information and triggering the frequency update mechanism in the presence of ultrasonic pollution, automatically detecting ultrasonic pollution and adjusting the monitoring and control of the ultrasonic frequency may be achieved, thereby effectively reducing or eliminating the influence of ultrasonic pollution on the monitoring environment and improving the accuracy of monitoring.

According to embodiments of the present disclosure, the method further includes: performing a grouting operation on the to-be-reinforced point by using the reinforcement tool; and stopping the grouting operation in a case that the settlement information of the widened embankment is detected to be less than the preset settlement threshold.

According to embodiments of the present disclosure, in the construction process of widening the road, the grouting bag may be driven at the interface of the vertical pile of the inclined pile embankment retaining structure and the edge of the fill soil of the newly-built embankment. The grouting bag may be flexible. In order to reduce damage to the grouting bag, a steel pipe may be sleeved outside the grouting bag. After the grouting bag is driven into the designated position, the steel pipe may be extracted and recycled. During the reinforcement operation, after a reinforcing grout is configured, the grouting pipe is inserted through a grouting device (such as a pipeline or operation interface of the grouting pump). When the settlement information of a target point is greater than the preset settlement threshold of the embankment, the monitoring device may automatically generate a reinforcement solution.

In a feasible embodiment, after receiving the settlement information, the processing device in the monitoring device or the server connected to the processing device analyzes the horizontal settlement position of the embankment, controls the grouting bag, and starts the grouting pump for grouting, so that the grouting is performed sequentially from the bottom grouting bag upwards. The length of the grouting pipe may be determined based on the elastic modulus of the soil at the target point and the total volume of reinforcing grout required to be injected. In the grouting operation, the first grouting pipe body passes through the second grouting pipe body, and when the first grouting pipe body reaches the position of the to-be-grouted bag, the first grouting pipe body is energized. A grouting port (a grout injection valve) in the first grouting pipe body is connected to a grout inlet (a grout discharge valve) of the second grouting pipe body, and the grouting is started. The grout passes through the first grouting pipe body, the grouting port, the second grouting pipe body, the grout inlet, and the grouting bag sequentially. When the monitoring device detects that the settlement information is less than the preset settlement threshold, the transmission of the settlement information is stopped, and the grouting pump may control the grouting bag within the to-be-reinforced range to no longer perform the grouting operation. When the entire road embankment meets the design elevation, it may be determined that the construction of this road is completed. It should be noted that after a preset period of time after the completion of construction, if the elevation of some regions of the road is greater than the design elevation, some grout may be discharged. The grouting port of the grouting pipe may be connected to the grout outlet of the grouting channel, and the relevant operation is the same as the grouting operation.

Based on the above-mentioned settlement monitoring and treatment method for the widened embankment with the inclined-vertical pile retaining structure, the present disclosure further provides a settlement monitoring and treatment apparatus for a widened embankment with an inclined-vertical pile retaining structure. The apparatus will be described in detail with reference to FIG. 7.

FIG. 7 shows a structural block diagram of a settlement monitoring and treatment apparatus for a widened embankment with an inclined-vertical pile retaining structure according to embodiments of the present disclosure.

As shown in FIG. 7, the settlement monitoring and treatment apparatus for the widened embankment with the inclined-vertical pile retaining structure in the embodiment includes a target ultrasound information acquisition module 710, a target ultrasound information conversion module 720, a signal loss information determination module 730, a settlement information determination module 740, and a reinforcement solution generation module 750.

The target ultrasound information acquisition module 710 is used to acquire target ultrasound information corresponding to a target point by using a monitoring device, where the monitoring device includes a generator, a converter, and a receiver. In an embodiment, the target ultrasound information acquisition module 710 may be used to perform the operation S210 described above, which will not be described in detail here.

The target ultrasound information conversion module 720 is used to convert the target ultrasound information by using the converter to obtain first electrical signal information and second electrical signal information, where the first electrical signal information represents information obtained after the converter converts first ultrasound information transmitted by the generator, and the second electrical signal information represents information obtained after the converter converts second ultrasound information received by the receiver. In an embodiment, the target ultrasound information conversion module 720 may be used to perform the operation S220 described above, which will not be described in detail here.

The signal loss information determination module 730 is used to determine signal loss information based on the first electrical signal information and the second electrical signal information. In an embodiment, the signal loss information determination module 730 may be used to perform the operation S230 described above, which will not be described in detail here.

The settlement information determination module 740 is used to determine settlement information between the target point and a surface of a widened embankment based on the signal loss information and distance information, where the distance information represents a vertical distance between the surface of the widened embankment and a reference surface. In an embodiment, the settlement information determination module 740 may be used to perform the operation S240 described above, which will not be described in detail here.

The reinforcement solution generation module 750 is used to generate a reinforcement solution corresponding to the widened embankment based on the settlement information, soil deformation information, and a preset reinforcement strategy, where the reinforcement solution includes to-be-reinforced range information and configuration information corresponding to a reinforcement tool. In an embodiment, the reinforcement solution generation module 750 may be used to perform the operation S250 described above, which will not be described in detail here.

According to the target ultrasound information acquisition module 710, the target ultrasound information conversion module 720, the signal loss information determination module 730, the settlement information determination module 740, and the reinforcement solution generation module 750 in the settlement monitoring and treatment apparatus for the widened embankment with the inclined-vertical pile retaining structure in embodiments of the present disclosure, first electrical signal information and second electrical signal information are automatically generated by converting target ultrasound information, so as to obtain signal loss information between the first electrical signal information and the second electrical signal information; settlement information between a target point and a surface of a widened embankment is generated in real time by combining the signal loss information with distance information; and then to-be-reinforced range information and reinforcement tool configuration information are automatically generated based on the settlement information, soil deformation information, and a preset reinforcement strategy. In this way, the waste of reinforcement device and reinforcement materials caused by inaccurate detection of the to-be-reinforced range is avoided, reinforcement costs are reduced, and reinforcement of the widened embankment is achieved. Since the settlement monitoring of the embankment may be achieved by only using the electrical signal information of the target point and the distance information, the amount of calculation information is small, which saves the consumption of system resources, improves the monitoring efficiency, and fills a technical gap in the field of settlement monitoring and settlement repair and reinforcement technology for the embankment with an inclined-vertical pile retaining structure in the related art.

According to embodiments of the present disclosure, the second electrical signal information is determined by the following operation: receiving, by using the receiver, the first ultrasound information after being reflected to generate the second ultrasound information, where an ultrasound frequency of the first ultrasound information is the same as an ultrasound frequency of the second ultrasound information; and converting the second ultrasound information by using the converter to obtain the second electrical signal information.

According to embodiments of the present disclosure, the reinforcement solution generation module includes: a to-be-reinforced range information determination sub-module and a configuration information determination sub-module. The to-be-reinforced range information determination sub-module is used to determine to-be-reinforced range information based on the settlement information and the preset settlement threshold. The configuration information determination sub-module is used to determine configuration information based on the to-be-reinforced range information, the soil deformation information, and the preset reinforcement strategy.

According to embodiments of the present disclosure, the to-be-reinforced range information determination sub-module includes: a to-be-reinforced range information determination unit used to determine to-be-reinforced range information in a case that the settlement information is greater than or equal to a preset settlement threshold. The to-be-reinforced range information represents region information formed by at least one to-be-reinforced point.

According to embodiments of the present disclosure, the soil deformation information represents deformation feature information of soil at the target point under stress. The configuration information determination sub-module includes a soil deformation information acquisition unit and a configuration information determination unit. The soil deformation information acquisition unit is used to acquire reinforcement energy efficiency information and the soil deformation information, where the reinforcement energy efficiency information represents reinforcement capability information of the reinforcement tool for a to-be-reinforced point, and the reinforcement energy efficiency information is associated with soil deformation information at the to-be-reinforced point. The configuration information determination unit is used to determine the configuration information based on the soil deformation information, the reinforcement energy efficiency information, the to-be-reinforced range information, and the preset reinforcement strategy, where the configuration information includes quantity information and location information corresponding to the reinforcement tool.

According to embodiments of the present disclosure, the apparatus further includes a target ultrasound information generation module and a frequency information update module. The target ultrasound information generation module is used to generate a plurality of target ultrasound information having different frequency information. The frequency information update module is used to: trigger a frequency update mechanism in response to detecting a presence of interference information in environmental information, so as to update frequency information corresponding to the target ultrasound information and acquire an updated target ultrasound information, where the interference information represents information having a same ultrasound frequency as the target ultrasound information, and an updated frequency information is ultrasound frequency information not appeared in the environmental information.

According to embodiments of the present disclosure, the apparatus further includes a grouting operation module and a stopping module. The grouting operation module is used to perform a grouting operation on the to-be-reinforced point by using the reinforcement tool. The stopping module is used to stop the grouting operation in a case that the settlement information of the widened embankment is detected to be less than the preset settlement threshold.

According to embodiments of the present disclosure, any number of the target ultrasound information acquisition module 710, the target ultrasound information conversion module 720, the signal loss information determination module 730, the settlement information determination module 740, and the reinforcement solution generation module 750 may be combined into one module to be implemented or any one of the modules may be divided into a plurality of modules. Alternatively, at least part of the function of one or more of these modules may be combined with at least part of the function of other modules and implemented in one module. According to embodiments of the present disclosure, at least one of the target ultrasound information acquisition module 710, the target ultrasound information conversion module 720, the signal loss information determination module 730, the settlement information determination module 740, and the reinforcement solution generation module 750 may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by any other reasonable means of hardware or firmware that integrates or packages a circuit, or may be implemented in any one of or a suitable combination of three implementation methods of software, hardware and firmware. Alternatively, at least one of the target ultrasound information acquisition module 710, the target ultrasound information conversion module 720, the signal loss information determination module 730, the settlement information determination module 740, and the reinforcement solution generation module 750 may be implemented at least partially as a computer program module. When the computer program module is executed, a corresponding function may be performed.

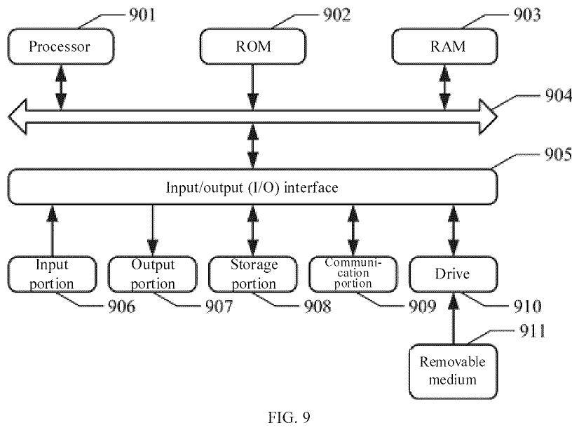

FIG. 8 shows front view and top view schematic diagrams of a reinforcement tool according to embodiments of the present disclosure.

As shown in FIG. 8, figure (a) is a front view schematic diagram of the reinforcement tool, and figure (b) is a top view schematic diagram of the reinforcement tool. The reinforcement tool includes: a grouting pipe body 1 constructed as a hollow metal pipe body and configured to input or output a reinforcing grout, where the grouting pipe body 1 includes a first grouting pipe body 11 and a second grouting pipe body 12, the diameter of the first grouting pipe body 11 is less than the diameter of the second grouting pipe body 12, a first end of the first grouting pipe body 11 is detachably connected to a grout supply device, and a second end of the first grouting pipe body 11 is detachably connected to a first end of the second grouting pipe body 12; and a grouting bag 2 constructed at an interface between a widened embankment and a pile body and configured to inject the reinforcing grout, where a second end of the second grouting pipe body 12 is detachably connected to a first end of the grouting bag 2.

According to embodiments of the present disclosure, the reinforcement tool may include the grouting bag 2 and the grouting pipe body 1. The grouting pipe body 1 and the grouting bag 2 may be connected through either threaded or snap-fit coupling, and the specific connection method may be determined according to actual needs, which is not limited here.

It may be understood that a plurality of grouting bags may be combined in series to form a stacked cylindrical grouting bag, and the individual grouting bags are connected by prefabricated spiral keys. The grouting pipe body 1 may be arranged at the center position of the grouting bag 2. The grouting pipe body 1 is made of a thin-walled hollow steel pipe. The first end of the first grouting pipe body 11 is detachably connected to a grout supply device (such as a grouting pump, an automatic pump). The grouting pump may adjust the grouting pressure to switch between grout injection and grout discharge. The second end of the first grouting pipe body 11 is detachably connected to the first end of the second grouting pipe body 12. A grouting hole is reserved near the top position of the first grouting pipe body 11, and an electromagnet is arranged near the grouting hole. The second grouting pipe body 12 is embedded inside the grouting bag 2, and has a diameter greater than the diameter of the first grouting pipe body 11. It may be understood that the first grouting pipe body 11 is a movable pipe body, and its length is determined by the total depth of the grouting bag to meet the grouting standard. Detachable connection between the grouting bags may be achieved using the second grouting pipe body 12.

According to embodiments of the present disclosure, the first grouting pipe body 11 further includes a grout injection valve, and the second grouting pipe body 12 further includes a grout discharge valve. The grout injection valve is constructed to communicate with the grout discharge valve and configured to perform grout injection or grout discharge according to a pressure value applied by the grout supply device.

According to embodiments of the present disclosure, the angle between the grout injection valve and the grout discharge valve may be 180°. Both the grout injection valve and the grout discharge valve are fixed magnet one-way valves. The grout injection valve is used to input the grout, and the grout discharge valve is used to discharge the grout.

In a feasible embodiment, during the grout injection process, the first grouting pipe body 11 needs to be inserted into the second grouting pipe body 12; after reaching the designated grouting bag position, the grouting pipe body 1 is energized, and the grouting port of the first grouting pipe body 11 is connected to the grout inlet of the second grouting pipe body 12; and the grouting pump is pressurized to achieve grout injection. It may be understood that during the grout discharge process, the first grouting pipe body 11 needs to be inserted into the second grouting pipe body 12; after reaching the designated grouting bag position, the grouting pipe body 1 is energized, and the grouting port of the first grouting pipe body 11 is connected to the grout outlet of the second grouting pipe body 12; and the grouting pump is depressurized to achieve grout discharge.

It should be noted that during the grouting operation, the grouting may be performed sequentially from the lower grouting bag to the upper grouting bag. The grouting may also be performed for several grouting bags among the plurality of grouting bags connected in series according to the position data of the target point. When the settlement of the widened embankment is restored to the design elevation of the road, the settlement monitoring device stops transmitting signals and the grouting bags stop grouting.

According to embodiments of the present disclosure, the grouting bag may be customized according to specific needs, and the length of the grouting bag may be adjusted according to the settlement points with different depths. This flexibility allows the grouting bags of appropriate length to be designed and arranged for each settlement point, ensuring the accuracy and effectiveness of reinforcement. Compared with overall coverage or extensive reinforcement, the hierarchical use of grouting bags may more accurately inject reinforcement materials, avoid unnecessary waste, reduce construction costs, and improve the construction efficiency.

In a feasible embodiment, the material of the reinforcing grout may include: 120 parts by mass of cement, 80 parts by mass of water, 30 parts by mass of bentonite, 30 parts by mass of fly ash, 0.5 parts by mass of water reducer, and 0.5 parts by mass of air entraining agent (rosin lipids).

In another feasible embodiment, the material of the reinforcing grout may further include: 100 parts by mass of epoxy resin, 20 parts by mass of methyl cellosolve, 20 parts by mass of pine oil, 10 parts by mass of copper powder, 10 parts by mass of nickel powder, and 50 parts by mass of graphite powder.

FIG. 9 shows a block diagram of an electronic device adapted to implement a settlement monitoring and treatment method for a widened embankment with an inclined-vertical pile retaining structure according to embodiments of the present disclosure.

As shown in FIG. 9, the electronic device according to embodiments of the present disclosure includes a processor 901 that may perform various appropriate actions and processes according to programs stored in a read-only memory (ROM) 902 or programs loaded from a storage portion 908 into a random access memory (RAM) 903. The processor 901 may include, for example, a general-purpose microprocessor (e.g., a CPU), an instruction set processor and/or a related chipset and/or a special-purpose microprocessor (e.g., an application-specific integrated circuit (ASIC)), etc. The processor 901 may also include an on-board memory for caching purposes. The processor 901 may include a single processing unit or a plurality of processing units for performing different actions of a method flow according to embodiments of the present disclosure.

In the RAM 903, various programs and data required for the operation of the electronic device 900 are stored. The processor 901, the ROM 902 and the RAM 903 are connected to each other through a bus 904. The processor 901 performs various operations of the method flow according to embodiments of the present disclosure by executing the programs in the ROM 902 and/or the RAM 903. It should be noted that the programs may also be stored in one or more memories other than the ROM 902 and the RAM 903. The processor 901 may also perform various operations of the method flow according to embodiments of the present disclosure by executing the programs stored in the one or more memories.

According to embodiments of the present disclosure, the electronic device 900 may also include an input/output (I/O) interface 905, and the input/output (I/O) interface 905 is also connected to the bus 904. The electronic device 900 may also include one or more of the following components connected to the I/O interface 905: an input portion 906 including a keyboard, a mouse, etc.; an output portion 907 including a cathode ray tube (CRT), a liquid crystal display (LCD), etc., and a speaker, etc.; a storage portion 908 including a hard disk, etc.; and a communication portion 909 including a network interface card such as a LAN card, a modem, etc. The communication portion 909 performs communication processing via a network such as the Internet. A drive 910 is also connected to the I/O interface 905 as needed. A removable medium 911, such as a magnetic disk, an optical disk, a magneto-optical disk, a semiconductor memory, etc., is mounted on the drive 910 as needed so that a computer program read therefrom is installed into the storage portion 908 as needed.

The present disclosure further provides a computer-readable storage medium. The computer-readable storage medium may be included in the device/apparatus/system described in the above-mentioned embodiments, and may also exist alone without being assembled into the device/apparatus/system. The computer-readable storage medium described above carries one or more programs, and when the one or more programs are executed, the method according to embodiments of the present disclosure may be implemented.

According to embodiments of the present disclosure, the computer-readable storage medium may be a nonvolatile computer-readable storage medium. The computer-readable storage medium may include, but not limited to, a portable computer disk, a hard disk, a random access memory (RAM), a read only memory (ROM), an erasable programmable read only memory (EPROM or flash memory), a portable compact disk read only memory (CD-ROM), an optical storage device, a magnetic storage device, or any suitable combination of the above. In the present disclosure, the computer-readable storage medium may be any tangible medium that contains or stores a program that may be used by or in conjunction with an instruction execution system, apparatus, or device. For example, according to embodiments of the present disclosure, the computer-readable storage medium may include one or more memories other than the ROM 902 and/or the RAM 903 and/or the ROM 902 and the RAM 903 described above.

Embodiments of the present disclosure further include a computer program product which includes a computer program. The computer program includes program codes for implementing the method shown in the flowchart. When the computer program product runs in a computer system, the program codes are used to enable the computer system to implement the settlement monitoring and treatment method for the widened embankment with the inclined-vertical pile retaining structure provided by embodiments of the present disclosure.

The computer program, when executed by the processor 901, performs the functions described above defined in the system/apparatus of embodiments of the present disclosure. According to embodiments of the present disclosure, the system, apparatus, module, unit, etc. described above may be implemented by the computer program module.

In an embodiment, the computer program may rely on a tangible storage medium such as an optical storage device and a magnetic storage device. In another embodiment, the computer program may also be transmitted and distributed in a form of signals on a network medium, downloaded and installed through the communication portion 909, and/or installed from the removable medium 911. The program code contained in the computer program may be transmitted by any appropriate network medium, including but not limited to: wireless, wired, etc., or any suitable combination of the above.

In such an embodiment, the computer program may be downloaded and installed from the network via the communication portion 909, and/or installed from the removable medium 911. The computer program, when executed by the processor 901, performs the functions described above defined in the system of embodiments of the present disclosure. According to embodiments of the present disclosure, the system, device, apparatus, module, unit, etc. described above may be implemented by the computer program module.

According to embodiments of the present disclosure, program codes for implementing the computer programs provided by embodiments of the present disclosure may be written in one or more programming languages. Specifically, the computing programs may be implemented using advanced procedure-oriented and/or object-oriented programming languages, and/or assembler/machine languages. Programming languages include but are not limited to Java, C++, Python, “C” or similar programming languages. The program codes may be executed entirely on a user computing device, partially on a user device and partially on a remote computing device, or entirely on a remote computing device or server. In situations involving the remote computing device, the remote computing device may be connected to the user computing device through any kind of network, including a local area network (LAN) or a wide area network (WAN), or may be connected to an external computing device (for example, using an Internet service provider to connect via the Internet).

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, program segment, or portion of code, which contains one or more executable instructions for implementing the specified logical function. It should also be noted that, in some alternative implementations, the functions noted in the blocks may not occur in the order noted in the drawings. For example, two blocks shown in succession may, in fact, be executed substantially concurrently, or the two blocks may sometimes be executed in a reverse order, depending upon the functionality involved. It should also be noted that each block of the block diagrams or flowcharts, and combinations of the blocks in the block diagrams or flowcharts, may be implemented by using a special purpose hardware-based system that performs the specified functions or operations, or may be implemented using a combination of a special purpose hardware and computer instructions.

Those skilled in the art may understand that features recited in the various embodiments of the present disclosure and/or the claims may be combined and/or incorporated in a variety of ways, even if such combinations or incorporations are not clearly recited in the present disclosure. In particular, the features recited in the various embodiments of the present disclosure and/or the claims may be combined and/or incorporated in a variety of ways without departing from the spirit and teachings of the present disclosure, and all such combinations and/or incorporations fall within the scope of the present disclosure.

Embodiments of the present disclosure have been described above. However, these embodiments are for illustrative purposes only, and are not intended to limit the scope of the present disclosure. Although the various embodiments are described above separately, this does not mean that the measures in the various embodiments may not be advantageously used in combination. The scope of the present disclosure is defined by the appended claims and their equivalents. Without departing from the scope of the present disclosure, those skilled in the art may make various substitutions and modifications, and these substitutions and modifications should all fall within the scope of the present disclosure.

1. A settlement monitoring and treatment method for a widened embankment with an inclined-vertical pile retaining structure, comprising:
acquiring target ultrasound information corresponding to a target point by using a monitoring device, wherein the monitoring device comprises a generator, a converter, and a receiver;
converting the target ultrasound information by using the converter to obtain first electrical signal information and second electrical signal information, wherein the first electrical signal information represents information obtained after the converter converts first ultrasound information transmitted by the generator, and the second electrical signal information represents information obtained after the converter converts second ultrasound information received by the receiver;
determining signal loss information based on the first electrical signal information and the second electrical signal information;
determining settlement information between the target point and a surface of a widened embankment based on the signal loss information and distance information, wherein the distance information represents a vertical distance between the surface of the widened embankment and a reference surface; and
generating a reinforcement solution corresponding to the widened embankment based on the settlement information, soil deformation information, and a preset reinforcement strategy, wherein the reinforcement solution comprises to-be-reinforced range information and configuration information corresponding to a reinforcement tool.

2. The method according to claim 1, wherein the second electrical signal information is determined by:
receiving, by using the receiver, the first ultrasound information after being reflected to generate the second ultrasound information, wherein an ultrasound frequency of the first ultrasound information is the same as an ultrasound frequency of the second ultrasound information; and
converting the second ultrasound information by using the converter to obtain the second electrical signal information.

3. The method according to claim 1, wherein the generating a reinforcement solution corresponding to the widened embankment based on the settlement information, soil deformation information, and a preset reinforcement strategy comprises:
determining the to-be-reinforced range information based on the settlement information and a preset settlement threshold; and
determining the configuration information based on the to-be-reinforced range information, the soil deformation information, and the preset reinforcement strategy.

4. The method according to claim 3, wherein the determining the to-be-reinforced range information based on the settlement information and a preset settlement threshold comprises:
determining the to-be-reinforced range information in a case that the settlement information is greater than or equal to the preset settlement threshold, wherein the to-be-reinforced range information represents region information formed by at least one to-be-reinforced point.

5. The method according to claim 3, wherein the soil deformation information represents deformation feature information of soil at the target point under stress,
wherein the determining the configuration information based on the to-be-reinforced range information, the soil deformation information, and the preset reinforcement strategy comprises:
acquiring reinforcement energy efficiency information and the soil deformation information, wherein the reinforcement energy efficiency information represents reinforcement capability information of the reinforcement tool for a to-be-reinforced point, and the reinforcement energy efficiency information is associated with the soil deformation information at the to-be-reinforced point; and
determining the configuration information based on the soil deformation information, the reinforcement energy efficiency information, the to-be-reinforced range information, and the preset reinforcement strategy, wherein the configuration information comprises quantity information and location information corresponding to the reinforcement tool.

6. The method according to claim 1, further comprising:
generating a plurality of target ultrasound information having different frequency information; and
triggering a frequency update mechanism in response to detecting a presence of interference information in environmental information, so as to update frequency information corresponding to the target ultrasound information and acquire an updated target ultrasound information, wherein the interference information represents information having a same ultrasound frequency as the target ultrasound information, and an updated frequency information is ultrasound frequency information not appeared in the environmental information.

7. The method according to claim 4, further comprising:
performing a grouting operation on the to-be-reinforced point by using the reinforcement tool; and
stopping the grouting operation in a case that the settlement information of the widened embankment is detected to be less than the preset settlement threshold.

8. (canceled)

9. A reinforcement tool for the method according to claim 1, comprising:
a grouting pipe body constructed as a hollow metal pipe body and configured to input or output a reinforcing grout, wherein the grouting pipe body comprises a first grouting pipe body and a second grouting pipe body, a diameter of the first grouting pipe body is less than a diameter of the second grouting pipe body, a first end of the first grouting pipe body is detachably connected to a grout supply device, and a second end of the first grouting pipe body is detachably connected to a first end of the second grouting pipe body; and
a grouting bag constructed at an interface between a widened embankment and a pile body and configured to inject the reinforcing grout, wherein a second end of the second grouting pipe body is detachably connected to a first end of the grouting bag.

10. The reinforcement tool according to claim 9, wherein the first grouting pipe body further comprises a grout injection valve, the second grouting pipe body further comprises a grout discharge valve, and the grout injection valve is constructed to communicate with the grout discharge valve and configured to perform grout injection or grout discharge according to a pressure value applied by the grout supply device.
